(19) United States
(12) Patent Application Publication
(10) Pub. No.: US 2015/0063830 A1
(43) Pub. Date: Mar. 5, 2015

(54) CONTINUOUS WAVE ULTRAVIOLET LASER BASED ON STIMULATED RAMAN SCATTERING

(71) Applicant: NEWPORT CORPORATION, Irvine, CA (US)

(72) Inventors: Alan B. Petersen, Palo Alto, CA (US); James D. Kafka, Palo Alto, CA (US)

(73) Assignee: Newport Corporation, Irvine, CA (US)

(21) Appl. No.: 14/382,313

(22) PCT Filed: Mar. 14, 2013
(86) PCT No.: PCT/US13/31578

§ 371 Date: Aug. 30, 2014

Related U.S. Application Data
(60) Provisional application No. 61/611,994, filed on Mar. 16, 2012.

(51) Int. Cl. H04B 10/50; H04B 10/572

(52) U.S. Cl. CPC H04B 10/503; H04B 10/572
USPC 398/201

(57) ABSTRACT

The present application is directed to a laser system using Stimulated Raman Scattering and harmonic conversion to produce a continuous wave ultraviolet wavelength output signal. More specifically, the laser system includes a pump source configured to generate at least one pump signal, a resonant cavity resonant at a Stokes wavelength in optical communication with the pump source, a SRS gain device positioned within the resonant cavity and configured to generate at least one SRS output signal at a Stokes wavelength when pumped with the pump signal, and a harmonic conversion device positioned within the resonant cavity and configured to produce a continuous wave second harmonic output signal of the SRS output signal.

### CROSS REFERENCE TO RELATED APPLICATIONS

The present application claims priority to U.S. Provisional Patent Application Ser. No. 61/611/994, entitled “Continuous Wave Ultraviolet Laser Based on Stimulated Raman Scattering,” filed on Mar. 16, 2012, the entire contents of which are incorporated by reference herein.

### BACKGROUND

Numerous material processing and diagnostic applications, such as semiconductor processing and inspection, requires powerful diffraction-limited continuous wave (hereinafter CW) ultraviolet (hereinafter UV) laser light. Presently, the most efficient and practical CW laser sources operate at wavelengths considerably longer than UV wavelengths, thereby requiring harmonic conversion to a desired UV wavelength. For example, CW laser light sources outputting near IR wavelengths or longer may be used as a source.

One common CW laser source frequently used in industrial applications is a solid-state Nd laser system configured to output a laser signal at about 1064 nm. Thereafter, the 1064 nm output by the Nd laser system is efficiently converted to 532 nm using intracavity second harmonic generation processes. In some applications, particularly semiconductor inspection and processing applications, the second harmonic signal having a wavelength of about 532 nm undergoes an additional harmonic conversion resulting in a fourth harmonic wavelength of about 266 nm. To be efficient, the additional harmonic conversion requires that the 532 nm second harmonic signal have high optical intensity to produce a harmonic output signal at 266 nm having sufficient power to be useful. As such, often a 532 nm resonant ring cavity is required for the additional harmonic conversion of the 532 nm signal to produce a 266 nm signal having a usable intensity for semiconductor inspection and processing.

While the aforementioned method of generating CW UV laser light has proven useful in the past, a number of shortcomings have been identified. For example, the resonant ring cavity used for converting the 532 nm second harmonic signal to 266 nm signal requires very precise locking of the laser and ring resonances. Commonly, active locking of the two cavity lengths to a small fraction of a wavelength is required. In the past, this locking process has proven challenging and expensive. In addition, maintaining this interferometric accuracy for long periods of time has proven difficult.

Thus, in light of the foregoing, there is an ongoing need for a system capable of efficient CW wavelength conversion from wavelengths greater than about 500 nm to UV wavelengths without requiring the aforementioned precise locking requirements.

### SUMMARY

The present application is directed to a laser system configured to output a continuous wave output signal. More specifically, the laser system presented herein utilizes Stimulated Raman Scattering (SRS) to generate a Stimulated Raman Scattering output signal at a wavelength (the Stokes wavelength) slightly longer than the pump. Thereafter, the Stimulated Raman Scattering output signal may undergo harmonic conversion to produce a continuous wave ultraviolet wavelength output signal capable of being directed to a work surface or substrate. In one embodiment, the laser system includes at least one pump source configured to generate at least one pump signal having a wavelength of about 500 nm to about 550 nm, at least one resonant cavity in optical communication with the pump source, the resonant cavity resonant at a Stokes wavelength and defined by a first mirror and at least a second minor, at least one SRS gain device positioned within the resonant cavity, the SRS gain device configured to generate at least one SRS output signal at a Stokes wavelength when pumped with the pump signal, and at least one harmonic conversion device positioned within the resonant cavity, the harmonic conversion device configured to produce a second harmonic output signal of the SRS output signal, wherein the second minor is configured to output the second harmonic output signal produced by the harmonic conversion device.

In another embodiment, the present application is directed to a laser system and includes at least one pump source configured to generate at least one pump signal having a wavelength of about 400 nm to about 800 nm, at least one resonant cavity in optical communication with the pump source, the resonant cavity resonant at a Stokes wavelength and defined by a first minor and at least a second minor, at least one SRS gain device positioned within the resonant cavity, the SRS gain device configured to generate at least one SRS output signal at a Stokes wavelength when pumped with the pump signal, and at least one harmonic conversion device positioned within the resonant cavity, the harmonic conversion device configured to produce a second harmonic output signal of the SRS output signal, wherein the second minor is configured to output the second harmonic output signal produced by the harmonic conversion device.

Further, the present application discloses a method of inspecting a semiconductor wafer. More specifically, the present application discloses providing at least one pump laser configured to produce at least one pump signal having a wavelength of about 500 nm to about 550 nm, irradiating at least one SRS gain medium with the pump signal to produce at least one SRS output signal at a Stokes wavelength, irradiating at least one harmonic conversion device with the SRS output signal to produce a second harmonic output signal having a wavelength of about 270 to about 300 nm, directing the second harmonic output signal to a semiconductor wafer, and detecting light scattered from the semiconductor wafer.

Other features and advantages of the embodiments of the continuous wave ultraviolet wave laser system using Stimulated Raman Scattering as disclosed herein will become apparent from a consideration of the following detailed description.

### BRIEF DESCRIPTION OF THE DRAWINGS

Various embodiments of the continuous wave ultraviolet wave laser system using Stimulated Raman Scattering will be explained in more detail by way of the accompanying drawings, wherein:

FIG. 1 shows a schematic view of an embodiment of a continuous wave ultraviolet wave laser system using Stimulated Raman Scattering used for semiconductor wafer inspection.

### DETAILLED DESCRIPTION

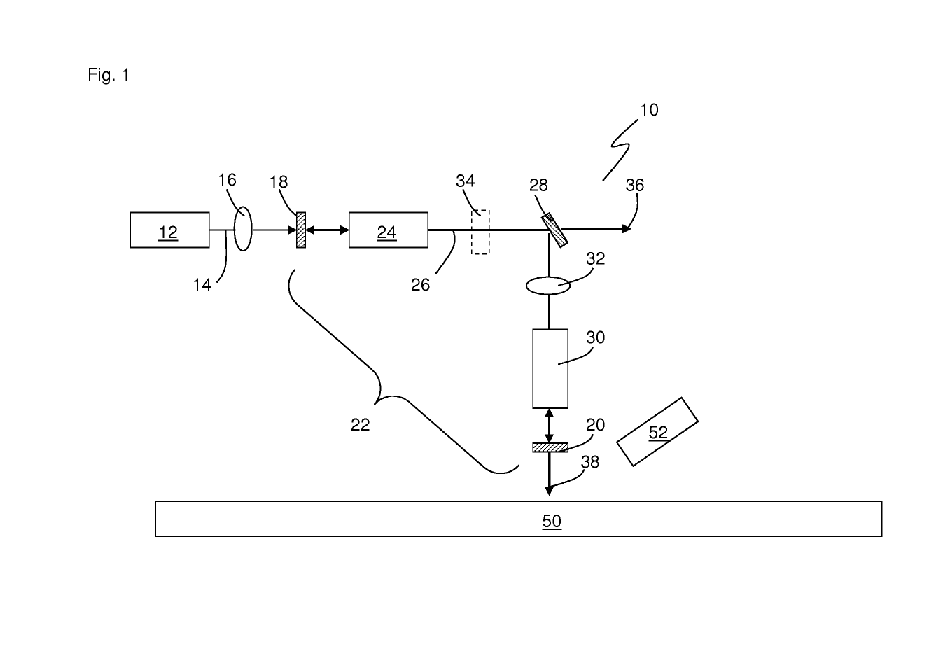

FIG. 1 shows an embodiment of a CW UV laser system 10 based on Stimulated Raman Scattering. In this process, a pump signal 14 incident on a Raman-active material 24 (hereinafter SRS gain device) generates a SRS output signal 26 (the Stokes wave) at a wavelength longer than that of the pump signal 14. The wavelength of the Stokes wave is determined by properties of the SRS gain device 24. As shown, the laser system 10 includes at least one pump laser 12 configured to output a CW pump signal 14 having a wavelength of about 400 nm to about 800 nm. In the illustrated embodiment a single pump laser 12 is used. In an alternate embodiment, multiple pump lasers 12 may be spatially and/or spectrally combined to result in the generation of one or more high power pump signals 14. Optionally, the pump laser beam may be passed through the SRS gain device 24 multiple times for increased pump intensity. In one embodiment the CW pump signal 14 has a wavelength of about 400 nm to about 800 nm. In another embodiment, the CW pump signal 14 has a wavelength of about 500 nm to about 550 nm. In a more specific embodiment, the CW pump signal 14 has a wavelength of about 532 nm. In one embodiment, the pump laser 12 comprises a CW diode pumped solid state laser. For example, the laser system 12 may comprise a Millennia™ laser manufactured by Spectra-Physics, Inc. Those skilled in the art will appreciate that any variety of laser systems or devices configured to output a CW pump signal 14 having a wavelength of about 400 nm to about 800 nm may be used with the present system.

Referring again to FIG. 1, one or more optical elements 16 may be used to focus or otherwise condition the CW pump signal 14. For example, in the illustrated embodiment, a lens or lens system 16 is used to focus the CW pump signal 14 to a point within the laser system 10. Any variety of optical elements 16 may be used with the present system, including, without limitations, mirrors, lenses, lens systems, gratings, etalons, and the like.

As shown in FIG. 1, the laser system 10 includes a first mirror 18, and at least a second mirror 20, the first and second mirrors 18, 20, respectively, defining at least one resonant cavity 22. Those skilled in the art will appreciate that any variety of mirrors may be used to form the resonant cavity 22. In the illustrated embodiment, the first mirror 18 comprises a bandpass mirror configured to transmit optical signals at the pump signal wavelength therethrough while reflecting virtually all optical signals at the Stokes wavelength. Similarly, the second mirror 20 likewise comprises a bandpass mirror configured to reflect the Stokes wavelength and transmit optical signal at a desired wavelength (e.g. a harmonic of a Stokes wavelength generated within the resonant cavity). As such, the second mirror 20 may form an output coupler configured to output CW laser light having a wavelength equal to a harmonic of a wavelength generated within the resonant cavity 22. Those skilled in the art will appreciate that the first mirror 18, second mirror 20, or both may form an output coupler. Further, in the illustrated embodiment, the optical element 16 is located outside the resonant cavity 22. Optionally, the optical element 16 may be positioned within the resonant cavity 22.

Referring again to FIG. 1, at least one SRS gain device 24 is positioned within the resonant cavity 22. In the illustrated embodiment, the SRS gain device 24 is positioned at the focal point of the optical element 16 positioned outside the resonant cavity 22. Optionally, the SRS gain device 24 may be positioned at any location within the resonant cavity 22. The SRS gain device 24 may be configured to generate at least one SRS output signal 26 at a desired Stokes wavelength when pumped with the pump signal 14. As such, the SRS gain device 24 may be constructed from any variety of materials known to generate a SRS output signal 26 at a desired Stokes wavelength. For example, in one embodiment, the SRS gain device 24 is manufactured from diamond having a single vibrational mode at about 1332 cm⁻¹, which results in the generation of an SRS optical signal 26 having a Stokes wavelength of about 573 nm In the alternative, the SRS gain device 24 may be constructed from KGW, KYW, Ba(NO₃)₂, BaWO₄, PbWO₄, CaWO₄, YVO₄, GdVO₄, LiNbO₃, SrMO₄, PbMO₄ or LiIO₃. Optionally, the SRS gain device 24 may include one or more dopants configured to provide different resonances, fluorescence and/or enhancement to the Raman gain, and the like. In the illustrated embodiment, a single SRS gain device 24 is positioned within the resonant cavity 22. In an alternate embodiment, multiple SRS gain devices 24 are positioned within the resonant cavity 22. Further, in the illustrated embodiment, the resonant cavity 22 is resonant at the Stokes wavelength produced by the SRS gain device 24. Optionally, the resonant cavity may be configured to be resonant at any variety of wavelengths.

As shown in FIG. 1, the resonant cavity 22 of laser system 10 may include a third minor 28 configured to transmit at least a portion of the pump light 14 having a wavelength of about 532 nm, while reflecting the SRS output signal 26 having a wavelength of about 573 nm Pump light 14 transmitted through minor 28 may optionally be reflected back through minor 28 for one or more additional passes through the SRS gain device 24 resulting in increased optical gain. Those skilled in the art will appreciate that the wavelength transmission/reflection characteristics of the minor 28 may be varied depending on the material used to manufacture the SRS gain device 24 and the resulting Stokes wavelength of the resultant SRS output signal 26. In short, minor 28 is configured to reflect the SRS output signal 26 at the Stokes wavelength while transmitting at least a portion of other wavelengths therethrough.

Referring again to FIG. 1, at least one harmonic conversion device 30 may be positioned within the resonant cavity 22. In the illustrated embodiment a single harmonic conversion device 30 is positioned between third minor 28 and the second mirror 20, although those skilled in the art will appreciate that the harmonic conversion device 30 may be positioned anywhere within the resonant cavity 22. In one embodiment, the harmonic conversion device 30 comprises at least one nonlinear optical material. Exemplary nonlinear optical materials include, without limitations, LBO, BBO, CLBO, KABO, DKDP, KTP, PPSLT, KDP, CBO, BIBO, LB4, KBBF, RBBF and the like. In one embodiment, the harmonic conversion device 30 is configured to generate a second harmonic output signal 38 of the SRS output signal 26. In the present case, the output signal 38 would have a wavelength of about 286 nm, which is the second harmonic of the SRS output signal 26, which has a Stokes wavelength of about 573 nm As such, the second minor 20 would be configured to transmit the output signal 38 having a wavelength of 286 nm, while reflecting the Stokes wavelength.

As shown in FIG. 1, one or more additional optical elements 32, 34 may be positioned within the resonant cavity. For example, as shown, at least one lens or lens system 32, 34 is positioned proximate to the harmonic conversion device 30 and configured to focus the SRS output signal 26 into at least a portion of the harmonic conversion device 30. Similarly, one or more lenses, lens systems, minor, and the like may be used within the resonant cavity 22.

Referring again to FIG. 1, in one embodiment the second harmonic output signal 38 transmitted through the second minor 20 may then be directed to into a semiconductor wafer 50 or into a semiconductor inspection system. More specifically, during use in semiconductor inspection applications, the laser system 10 disclosed herein may be configured such that the pump laser 12 outputs a pump signal 14 having a wavelength of about 500 nm to about 550 nm. Thereafter, the SRS gain device 24 may be irradiated with the pump signal 14 to produce at least one SRS output signal 26 at a Stokes wavelength. The SRS output signal 26 may then be used to irradiate the harmonic conversion device 30 to produce a second harmonic output signal 38 having a wavelength of about 270 to about 300 nm, which is then directed to a semiconductor wafer 50. Finally, a detector 52 may be used to detect light scattered from the semiconductor wafer 50. Those skilled in the art will appreciate that the present laser system 10 may be easily adapted for use in any variety of semiconductor inspection or processing system presently available and known in the art.

Unlike prior art systems, the present system utilizes a well developed green laser to efficiently and reliably generate CW UV light via stimulated Raman scattering, while avoiding the technical difficulties associated with precise interferometric locking of multiple optical resonators. Moreover, the SRS-based laser system above provides optical gain when pumped at any wavelength where the SRS material has sufficient optical transmission.

The embodiments disclosed herein are illustrative of the principles of the invention. Other modifications may be employed which are within the scope of the invention. Accordingly, the devices disclosed in the present application are not limited to that precisely as shown and described herein.

What we claim is:

1. A laser system, comprising:
at least one pump source configured to generate at least one pump signal, the pump source having a wavelength of about 500 nm to about 550 nm;
at least one resonant cavity in optical communication with the pump source, the resonant cavity resonant at a Stokes wavelength and defined by a first mirror and at least a second mirror;
at least one SRS gain device positioned within the resonant cavity, the SRS gain device configured to generate at least one SRS output signal at a Stokes wavelength when pumped with the pump signal; and
at least one harmonic conversion device positioned within the resonant cavity, the harmonic conversion device configured to produce a second harmonic output signal of the SRS output signal, wherein the second minor is configured to output the second harmonic output signal produced by the harmonic conversion device.

2. The device of claim 1 wherein the pump signal has a wavelength of about 532 nm.

3. The device of claim 1 wherein the pump laser comprises a diode pumped solid state laser.

4. The device of claim 1 further comprising at least one optical element configured to focus the pump signal into SRS gain device.

5. The device of claim 1 wherein the SRS gain device comprises diamond.

6. The device of claim 1 wherein the SRS output signal has a Stokes wavelength of about 573 nm.

7. The device of claim 1 wherein the harmonic conversion device comprises BBO.

8. The device of claim 1 wherein the second harmonic of the SRS output signal is about 286 nm.

9. The device of claim 1 further comprising at least one optical element positioned within the resonant cavity and configured to focus the SRS output signal into the harmonic conversion device.

10. A laser system, comprising:
at least one pump source configured to generate at least one pump signal, the pump source having a wavelength of about 400 nm to about 800 nm;
at least one resonant cavity in optical communication with the pump source, the resonant cavity resonant at a Stokes wavelength and defined by a first mirror and at least a second minor;
at least one SRS gain device positioned within the resonant cavity, the SRS gain device configured to generate at least one SRS output signal at a Stokes wavelength when pumped with the pump signal; and
at least one harmonic conversion device positioned within the resonant cavity, the harmonic conversion device configured to produce a second harmonic output signal of the SRS output signal, wherein the second minor is configured to output the second harmonic output signal produced by the harmonic conversion device.

11. The device of claim 10 wherein the pump signal has a wavelength of about 520 nm to about 570 nm.

12. The device of claim 10 further comprising at least one optical element configured to focus the pump signal into SRS gain device.

13. The device of claim 10 wherein the SRS gain device comprises diamond.

14. The device of claim 10 wherein the SRS gain device is manufactured from at least one material selected from the group consisting of KGW, KYW, Ba(NO₃)₂, BaWO₄, PbWO₄, CaWO₄, YVO₄, GdVO₄, LiNbO₃, SrMO₄, PbMO₄ or LiIO₃.

15. The device of claim 10 wherein the harmonic conversion device comprises BBO.

16. The device of claim 10 wherein the harmonic conversion device is manufactured from at least one material selected from the group consisting of LBO, BBO, CLBO, KABO, DKDP, KTP, PPSLT, KDP, CBO, BIBO, LB4, KBBF, RBBF

17. The device of claim 10 wherein the second harmonic of the SRS output signal is about 286 nm.

18. The device of claim 10 further comprising at least one optical element positioned within the resonant cavity and configured to focus the SRS output signal into the harmonic conversion device.

19. A method of inspecting a semiconductor wafer, comprising:
providing at least one pump laser configured to produce at least one pump signal having a wavelength of about 500 nm to about 550 nm;
irradiating at least one SRS gain medium with the pump signal to produce at least one SRS output signal at a Stokes wavelength;
irradiating at least one harmonic conversion device with the SRS output signal to produce a second harmonic output signal having a wavelength of about 270 to about 300 nm;
directing the second harmonic output signal to a semiconductor wafer; and
detecting light scattered from the semiconductor wafer.
